(19) United States
(12) Patent Application Publication
(10) Pub. No.: US 2007/0104575 A1
(43) Pub. Date: May 10, 2007

(54) TOUCH CONTROL SYSTEM FOR A FAN

(76) Inventor: SEH-CHOW WU, Hsing-Hsin Town (TW)

Correspondence Address: J.C. Patents, Suite 250, 4 Venture, Irvine, CA, 92618, US

(21) Appl. No.: 11/557,391

(22) Filed: Nov. 7, 2006

(30) Foreign Application Priority Data
Nov. 9, 2005 (CN) 200510115589.0

(51) Int. Cl. B64C 11/30

(52) U.S. Cl. 416/25

(57) ABSTRACT

A touch control system for a fan includes a touch input circuit, a microprocessor and a drive circuit electrically connected with one another. The touch input circuit receives a micro signal produced by a fan blade protective net when a user touches the protective net, and then converts the micro signal into a digital signal, which is transmitted to the microprocessor. Then the microprocessor treats the digital signal with a coded program signal, which is to be sent to the drive circuit. Then the drive circuit starts, shuts or changes its fan blade speed of the electric fan according to the coded program signal so that operation of the electric fan is controlled by a physical touch of a user on the protective net, without need of pressing a switch.

### CROSS-REFERENCE TO RELATED APPLICATION

This application claims priority benefit of Chinese application No. 200510115589.0filed on Nov. 9, 2005, the content of which is hereby incorporated by reference in its entirety.

### BACKGROUND OF THE INVENTION

1. Field of the Invention

This invention relates to a touch control system for a fan, particularly to one able to turn on and off a fan, and change its speed by touching a protective net of the fan without need of pressing the switch, easy to operate the fan.

2. Description of the Prior Art

Most conventional fans generally have a switch for turning on and off the fan or additionally provided with a wireless remote controller to control the switch.

### SUMMARY OF THE INVENTION

This invention has been devised to offer a touch control system for a fan to turn on and off the fan and change its speed by physically touching a protective net of the fan without pressing a switch. The invention has the following features.

1. It generates a control signal of micro capacity alteration caused by a user's physical touch on a protective net of a fan.

2. It has a touch input circuit for converting the control signals of micro capacity alteration into digital signals to be fed to a microprocessor.

3. It has a microprocessor for receiving the digital signals coming from the touch input circuit, and coding the signals into a coded program signal, which is to be fed to a driving circuit.

4. It has a drive circuit to operate the fan according to the coded program signal for turning on and off the fan, change its speed etc, without need of pressing a switch but by physically touching the protective net,

5. It uses the drive circuit having a conductor connected to the protective net, which is coated with an insulating material such as plastic, paint or lacquer, so a user's physical touch on any place of the protective net can activate the touch control system to operate the fan.

### BRIEF DESCRIPTION OF DRAWINGS

This invention will be better understood by referring to the accompanying drawings, wherein:

FIG. 1 is a block diagram of a touch control system for a fan in the present invention;

FIG. 2 is a diagram of the electric connections of the touch control system for a fan in the present invention;

FIG. 3 is a side view of the fan with its protective net being touched by a person for controlling the fan in the present invention.

### DETAILED DESCRIPTION OF THE PREFERRED EMBODIMENT

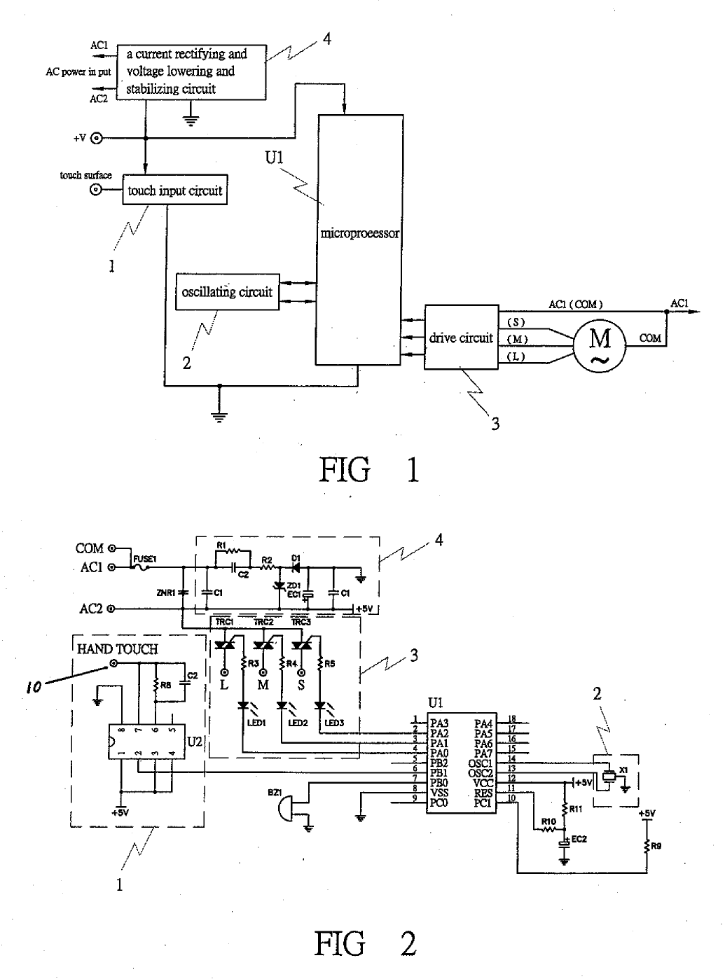

A preferred embodiment of a touch control system for a fan in the present invention, as shown in FIGS. 1 and 2, includes a touch input circuit 1, a micro processing circuit, a drive circuit 3, and a current rectifying and voltage lowering and stabilizing circuit 4 as main components combined together.

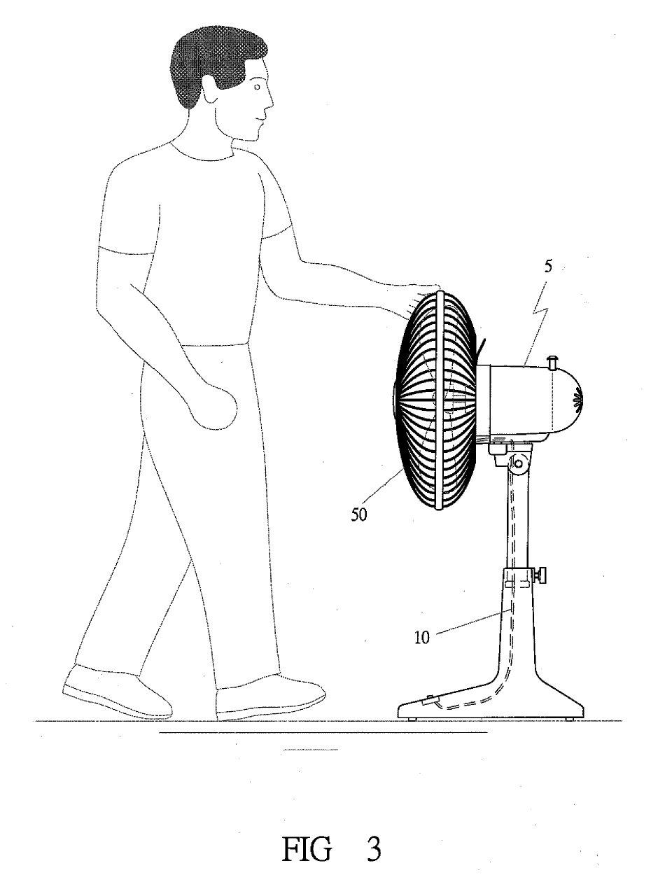

The touch input circuit 1 includes an integrated circuit (IC) U2, a resistor R8, a capacitor C2, and a conductor 10. The IC U2 is connected to the resistor R8 and the capacitor C2 in parallel and receives a touch signal of a micro capacity alteration caused by a user's physical touch on the metal protective net 50 of the fan 5, and then converts the touch signal into a digital signal. The conductor 10 is connected to the metal protective net 50 of the fan 5 and also connected to the IC U2. The metal protective net 50 has its surface coated with a layer of insulating material such as plastic, paint or lacquer of a proper thickness. The plastic, or the like does not affect the touch signal to be interfered. The invention is illustrated with a standing fan as shown in FIG. 3 in spite of the fact that this invention can be applied to various kinds of fans. The drive circuit 3 can be properly modified in its size according to the power of the fan motor. Then the touch input circuit 1 transmits the digital signal to a microprocessor U1 of the micro processing circuit.

The micro processing circuit includes a microprocessor U1 and an oscillating circuit 2. The oscillating circuit 2 supplies oscillation signals needed to the microprocessor U1, which receives the digital signal coming from the touch input circuit 1, and properly processes it into a coded program signal. Then the coded program signal is transmitted to the subsequent drive circuit 3.

The drive circuit 3 can be designed in accordance with an operational mode of a fan, controlling the fan motor to turn on and off, and its speed based on the coded program signal from the microprocessor U1. The drive circuit 3 includes three triacs , TRC1. TRC2 and TRC3, as shown in FIG. 2 for altering the fan speed in three levels, fast, medium and slow. It should be noted that the components and elements of the drive circuit 3 must be selected according to the power of the fan, The drive circuit shown in FIG. 2 is exemplary, and various modifications and variations can be made.

The current rectifying and voltage lowering and stabilizing circuit 4 is to rectify AC into DC, and then lower the voltage and stabilize the voltage.

Symbols shown in FIG. 2 have the following meanings R1-R11 are resistors. U1 is an integrated circuit, and PA3, PA2, PA1, PA0, PB2, PB1, PB0, VSS, PC0, PA4, PA5, PA6, PA7, OSC1, OSC2, VCC, RES, and PC1 are connecting points of U1. VCC is connected to a positive point of the power input. X1 is an oscillator. EC2 is a capacitor. C1-C2 are capacitors.

The invention can be applied to various kinds of electric fans, to turn on and off and change the speed of the fan motor by a user's physical touch on the protective net of the fan instead of pressing a switch, renovating the handling method of an electric fan.

While the preferred embodiment of the invention has been described above, it will be recognized and understood that various modifications may be made therein and the appended claims are intended to cover all such modifications that may fall within the spirit and scope of the invention.

What is claimed is:

1. A touch control system for a fan, said system comprising:
a touch input circuit comprising an IC for receiving a touch signal of a micro capacity alteration coming from a protective net of the fan when a user makes a physical touch on said protective net, said IC then converting said touch signal into a digital signal, which is then transmitted to a subsequent microprocessor;
a micro processing circuit comprising said microprocessor for receiving said digital signal from said touch input circuit and processing said digital signal into a coded program signal, which is then transmitted to a subsequent drive circuit; and,
said drive circuit for receiving said coded program signal and operating a fan motor according to said programmed code signal.

2. The touch control system for a fan as claimed in claim 1, wherein said IC of said touch input circuit is indirectly connected to a conductor via a resistor and a capacitor connected in parallel, and said conductor is connected to said protecting net of said fan.

3. The touch control system for a fan as claimed in claim 1, wherein said protective net of said fan is made of metal, and coated with insulating material such as plastic, paint or lacquer.

4. The touch control system for a fan as claimed in claim 1, wherein said micro processing circuit is composed of said microprocessor and an oscillating circuit.

5. The touch control system for a fan as claimed in claim 1, wherein said drive circuit is composed of plural triacs.

6. The touch control system for a fan as claimed in claim 1 further comprising a current rectifying and voltage lowering and stabilizing circuit.
